(19) United States
(12) Patent Application Publication
(10) Pub. No.: US 2008/0289346 A1
(43) Pub. Date: Nov. 27, 2008

(54) Refrigeration Circuit and Method of Operating a Refrigeration Circuit

(75) Inventors: Andreas Gernemann, Flensburg (DE); Bernd Heinbokel, Koln (DE)

Correspondence Address: BACHMAN & LAPOINTE, P.C. (UTC), 900 CHAPEL STREET, SUITE 1201, NEW HAVEN, CT, 06510-2802, US

(73) Assignee: LINDE KAELTETECHANIK GMBH & CO. KG, Koeln (DE)

(21) Appl. No.: 11/660,002

(22) PCT Filed: Aug. 5, 2005
(86) PCT No.: PCT/EP05/08535

§ 371 Date: May 2, 2008

(30) Foreign Application Priority Data
Aug. 9, 2004 (DE) 10 2004 038 641.2

(51) Int. Cl. F25B 41/04; F16K 31/02; F25D 3/00

(52) U.S. Cl. 62/222; 251/129.01; 62/56

(57) ABSTRACT

The invention relates to a refrigeration circuit having a mono- or multi-component refrigerant circulating therein, said refrigeration circuit comprising at least one expansion device. According to the invention, the expansion device is provided in the form of at least two valves (a, b, c, d) connected in parallel. Furthermore, the invention relates to a method of operating such a refrigeration circuit. Said method is characterized in that, in case of a defect of one of the valves (a, b, c, d) connected in parallel, said defective valve is taken out of operation and the or at least one of the additional valves ensures the control operation of the refrigeration circuit.

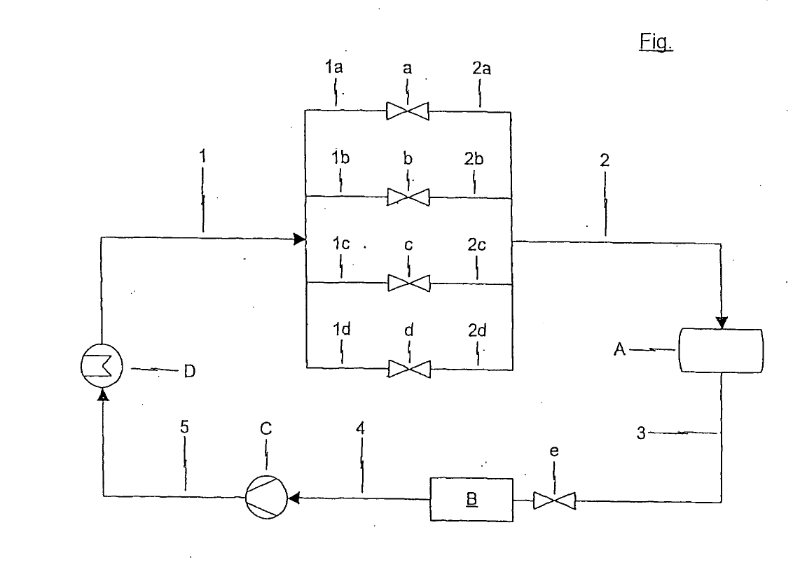

The invention relates to a refrigeration circuit having a mono- or multi-component refrigerant circulating therein, said refrigeration circuit comprising at least one expansion device.

Furthermore, the invention relates to a method of operating a refrigeration circuit.

Refrigeration circuits of the type concerned are well known. They are realized, for example, in refrigerating plants, so-called composite refrigerating plants, as used in supermarkets. In general, composite refrigerating plants feed there a multiplicity of cold consumers, such as cold storages, refrigerating and deep-freezing furniture. To this end, a mono- or multi-component refrigerant or refrigerant mixture circulates in the same. Such a refrigerant or refrigerant mixture is liquefied or condensed—preferably with respect to outside air—, and is fed via an optionally provided refrigerant collecting container to one or several cold consumers having injection valves arranged upstream thereof, and is evaporated in the same. By means of a single-stage or multi-stage compressor unit, the evaporated refrigerant then is compressed again to the desired high pressure of the refrigeration circuit and is again fed to the afore-mentioned condensation.

More recent (composite) refrigerating plants or refrigeration circuits using carbon dioxide as refrigerant and being operated at least temporarily in a supercritical or transcritical range, comprise a high-pressure control valve. The latter serves to expand the refrigerant from high pressure between 45 and 120 bar to an intermediate pressure of 30 to 40 bar. High-pressure control valves used so far are either motor control valves or pneumatic control valves for continuous control.

However, if a defect of any kind whatsoever occurs in such a valve, the entire refrigeration circuit has to be taken out of operation. This results in a multiplicity of apparent disadvantages.

It is the object of the present invention to indicate a refrigeration circuit as set out at the beginning as well as a method of operating a refrigeration circuit, in which the disadvantages mentioned are avoided.

The refrigeration circuit according to the invention distinguishes itself in that the expansion device is provided in the form of at least two valves connected in parallel.

According to an advantageous development of the refrigeration circuit of the invention, the valves employed are either of continuous control type or non-continuous control type.

As regards the method, the underlying object is met in that, in case of a defect of one of the valves connected in parallel, said defective valve is taken out of operation and the other or at least one of the other valves continues to ensure the control operation of the refrigeration circuit.

According to a development of the refrigeration circuit of the invention, it is suggested furthermore that at least two of the valves connected in parallel have different Kv values or pressure loss coefficients, respectively.

It is particularly advantageous if—in accordance with an additional advantageous development of the refrigeration circuit according to the invention—at least one of the valves is a magnetic valve.

The refrigeration circuit according to the invention, the inventive method of operating the refrigeration circuit as well as further developments thereof will be elucidated in more detail hereinafter by way of the embodiment shown in the drawing.

The drawing figure schematically shows a conventional refrigeration circuit in which a refrigerant flow having a pressure of e.g. 100 bar is supplied via line 1 to a valve block consisting of magnetic valves a, b, c, and d arranged or connected in parallel. With magnetic valves b, c and d being either closed or open, there takes place in magnetic valve a an expansion of the refrigerant to an (intermediate) pressure of 30 to 50 bar; to this end, the refrigerant is fed via line section 1a to the magnetic valve a and is expanded in the same and then is supplied via lines 2a and 2 to a refrigerant collecting container A connected upstream of cold consumer/heat exchanger B. From the refrigerant collecting container A, the refrigerant is supplied via line 3 to injection valve e of the cold consumer/heat exchanger B, is expanded in the same to the desired evaporation pressure and is evaporated in the cold consumer/heat exchanger B. The cold consumer/heat exchanger B as well as the injection valve e associated therewith in the present case stand for one or a plurality of cold consumers/heat exchangers arranged in parallel along with the related injection valves. Via line 4, the evaporated refrigerant is sucked into the single- or multi-stage compressor unit C, is again compressed in the same to the desired high pressure of the refrigeration circuit and is then supplied via line 5 to a condenser D.

In case of a defect occurring in or at valve a, said valve is taken out of operation, and at least one of the remaining, non-defective magnetic valves b, c and d, respectively, ensures the control operation of the refrigeration circuit and regulation of the high pressure, respectively.

The magnetic valves a to d used preferably operate only in a cyclic mode (on/off), in a pulse-width modulating mode or in a concatenated connection. The utilization of easily defective, expensive continuous-control valves now can be dispensed with according to the invention.

In a further development of the refrigeration circuit according to the invention it is suggested that the magnetic valves be arranged or seated in a common valve block.

In accordance with an advantageous development of the refrigeration circuit according to the invention, it is basically possible that the valves a to d used are of continuous control type and/or non-continuous control type.

It is thus possible to make use of or mutually combine either solely continuous control or solely non-continuous control valves as well as both continuous control and non-continuous control valves.

In case non-continuous control magnetic valves with different Kv values are employed and combined with each other, it is possible to realize different flow rates.

1. A refrigeration circuit having a mono- or multi-component refrigerant circulating therein, said refrigeration circuit comprising at least one expansion device,
characterized in that said expansion device is provided in the form of at least two valves (a, b, c, d) connected in parallel.

2. A refrigeration circuit according to claim 1, wherein said expansion device is arranged upstream of an injection valve (e) of a heat exchanger (B).

3. A refrigeration circuit according to claim 1, wherein the expansion device is arranged upstream of a refrigerant collecting container (A).

4. A refrigeration circuit according to claim 1, wherein the at least two valves (a, b, c, d) connected in parallel are high-pressure control valves.

5. A refrigeration circuit according to claim 1, wherein the high-pressure control valves are adapted to expand a refrigerant from a high pressure, which is between 45 and 120 bar, to an intermediate pressure between 30 and 50 bar.

6. A refrigeration circuit according to claim 1,
characterized in that valves (a, b, c, d) employed are of continuous control type and/or non-continuous control type.

7. A refrigeration circuit according to claim 1,
characterized in that at least one of the valves (a, b, c, d) is a magnetic valve.

8. A refrigeration circuit according to claim 1, in which at least two valves are magnetic valves,
characterized in that the magnetic valves are arranged in a valve block.

9. A refrigeration circuit according to claim 1,
wherein the refrigerant is carbon dioxide.

10. A refrigeration circuit according to claim 1,
wherein the at least two vales (a, b, c, d) connected in parallel have different Kv values.

11. A method of operating a refrigeration circuit according to claim 1,
characterized in that, in case of a defect of one of the valves (a, b, c, d) connected in parallel, said defective valve is taken out of operation and the or at least one of the additional valves ensures the control operation of the refrigeration circuit.

12. A method according to claim 11,
wherein said refrigeration circuit is operated in supercritical or transcritical manner.

13. A method according to claim 11,
wherein different flow rates are realized by combination of non-continuous control magnetic valves with different Kv values.
